(19) United States
(12) Patent Application Publication
(10) Pub. No.: US 2018/0040864 A1
(43) Pub. Date: Feb. 8, 2018

(54) BATTERY PACK FOR A HANDHELD MACHINE TOOL

(71) Applicant: Robert Bosch GmbH, Stuttgart (DE)

(72) Inventors: Marcin Rejman, Waiblingen (DE); Thorsten Seidel, Remseck (DE)

(21) Appl. No.: 15/555,338

(22) PCT Filed: Mar. 3, 2016
(86) PCT No.: PCT/EP2016/054506

§ 371 Date: Sep. 1, 2017

(30) Foreign Application Priority Data
Mar. 6, 2015 (DE) 10 2015 204 055.0
Sep. 23, 2015 (DE) 10 2015 218 261.4
Mar. 2, 2016 (DE) 10 2016 203 424.3

(51) Int. Cl. H01M 2/10; H01M 10/653; H01M 10/613

(52) U.S. Cl. CPC H01M 2/1055; H01M 10/613; H01M 10/653; H01M 10/643

(57) ABSTRACT

A battery pack for a handheld machine tool, having a cell holder and at least one battery cell, the cell holder accommodating the at least one battery cell, and the battery cell having a lateral area that extends parallel to a longitudinal axis, the lateral area being delimited by two end faces that extend at a right angle to the longitudinal axis and on which the electrical poles of the battery cell are located. At least one elastic, heat-conductive insert is situated between at least one end face of the battery cell and a wall of the battery pack housing extending parallel to the end face of the battery cell. The elastic, heat-conductive insert is in thermal contact with the end face of the battery cell and dissipates heat from the battery cell in the direction of the wall of the battery pack housing.

### FIELD

The present invention relates to a battery pack for a handheld machine tool.

### BACKGROUND INFORMATION

Generally, electrical handheld machine tools such as impact wrenches, drilling machines, angle grinders, jigsaws, circular saws or planing machines for the craftsmen or do-it-yourselfer use either an alternating current motor or a direct current motor as drive motor. While the former is usually supplied with an alternating current from the grid via a mains cable, the electrical energy for the supply of the direct current motor normally comes from what is known as a battery pack, i.e., a rechargeable accumulator in a housing that is able to be coupled with the housing of the handheld machine tool and is electrically connected to the current supply lines of the direct current motor when the two housings are coupled.

Such conventional battery packs include rechargeable accumulators, normally a plurality of battery cells connected in a parallel and/or series circuit. Herein, such a battery pack therefore denotes a battery pack that is preferably made up of a plurality of electrically interconnected battery cells. This battery pack is able to store electrical energy, supplies the energy for the operation of the handheld machine tool, and is accommodated in an exchangeable manner in a chamber, an interface or the like of the handheld machine tool. The allocation of the battery pack to the handheld machine tool is implemented by inserting or sliding the battery pack into a complementary insert bushing of the device housing. The battery pack is able to be coupled with the device housing of the handheld machine tool in such a way that the electric tool is electrically coupled with the battery pack and mechanically locked when the two housings are coupled. The electrical contacting normally takes place in the region of the locking device.

The battery packs have the disadvantage that each battery cell experiences heat losses both during the current delivery and the current draw, which may lead to an increased temperature of the entire battery block. To prevent damage to the battery cell and/or the battery block, heat losses must be dissipated in a reliable manner on the one hand, and heating of the battery pack at low outside temperatures must be possible on the other, which is advantageous especially in the case of cells that are chemically based on lithium.

In addition, such battery packs have housings that are made of plastic materials for the most part. Plastic materials generally used for battery pack housings include acrylonitrile-butadiene-styrene (ABS), polycarbonate (PC), or polyamide (PA). These plastic materials have excellent mechanical properties and adequate thermal conductivity, which makes them suitable for use as battery pack housings for most of the battery cells that are currently on the market, such as lithium-ion cells. However, these have the disadvantage of providing good thermal insulation. This is not desired in a battery pack inasmuch as the heat created during the operation or charging of the battery pack is to be dissipated as quickly as possible.

Moreover, the development of more recent battery packs goes in the direction of a greater power output, meaning that the heat losses are becoming greater as well; as a result, more heat is generated in the interior of the housing and must be dissipated into the environment more rapidly so as to avert overheating of the battery cells.

In addition, more and more battery pack housings are developed in tightly sealed form for the most part in order to prevent the entry of moisture, which means that the heat dissipation must take place through the wall of the housing.

### SUMMARY

It is an object of the present invention to mitigate the aforementioned disadvantages and to provide a battery pack for a handheld machine tool that features a more optimal dissipation of the generated heat losses. The battery pack according to the present invention may also offer excellent ergonomics and assembly capabilities and have a cost-effective and uncomplicated structure.

Advantageous refinements, variants and further developments of the present invention are described herein.

According to the present invention, an example battery pack for a handheld machine tool includes a cell holder and at least one battery cell; the cell holder accommodates the at least one battery cell, and the battery cell has a lateral area that extends parallel to a longitudinal axis x. The lateral area is delimited by two end faces disposed at a right angle to longitudinal axis x, at which the electrical poles of the battery cell are situated. At least one elastic, heat-conductive insert is disposed between at least one end face of the battery cell and a wall of the battery pack housing extending essentially parallel to the end face of the battery cell. The elastic, heat-conductive insert is in thermal contact with the end face of the battery cell and dissipates heat from the battery cell in the direction of the wall of the battery pack housing. It is advantageously provided that the elastic, heat-conductive insert is situated between the end face of the battery cell and a wall of the battery pack housing that is situated essentially at a right angle to longitudinal axis x of the battery cell.

In one particularly preferred specific embodiment of the present invention, at least one heat distribution element is disposed between the at least one elastic, heat-conductive insert and the wall of the battery pack housing, in the region of the at least one end face of the at least one battery cell. The heat distribution element is in thermal contact with the elastic, heat-conductive insert and with the wall of the battery pack housing and ensures an even application of heat to the wall of the battery pack housing.

It may be advantageous to produce the at least one heat-conductive insert at least partially from a thermally conductive material that belongs to at least one of the material groups of elastomers, thermo-plastic elastomers, or carbon fibers. The plastic materials such as acrylonitrile-butadiene-styrene (ABS), polycarbonate (PC), or polyamide (PA), e.g., PA6 or PA12, usually have good mechanical properties and an adequate thermal conductivity of 0.17 W/mK (ABS), 0.21 W/mK (PC), and 0.29 W/mk (PA6). This makes them suitable for use as battery pack housings for most of the battery cells that are currently on the market. According to the present invention, the heat-conductive insert has a thermal conductivity that is greater than 0.15 W/mK, and preferably greater than 0.20 W/mK, and most preferably, lies between 0.20 W/mK and 0.50 W/mK. If the thermally conductive insert has a wall thickness of less than 1 mm, the thermal conductivity may also be less than 0.15 W/mK, and preferably may amount to exactly 0.15 W/mK. Preferably, the heat-conductive insert has a Shore hardness of less than 50 Shore A, and preferably of between 20 Shore A and 45 Shore A.

According to an example embodiment of the present invention, the heat distribution element is at least partially made of a metal, preferably an aluminum or a magnesium alloy, or of a heat-conducting plastic. The heat distribution element advantageously is a planar component having a length L, a width B, and a thickness D. Thickness D is small in comparison with length L and width B, and heat distribution element has a plurality of recesses distributed across its surface. This makes it possible to dissipate the heat to be carried away in an especially advantageous manner such that it is distributed across the battery pack housing.

In one preferred specific embodiment, the heat distribution element is developed as a metal foil having a thickness of between 0.1 mm and 0.5 mm, and preferably of between 0.01 mm and 0.3 mm, or it is developed as a graphite layer at a thickness of between 0.1 mm and 0.5 mm, and preferably of between 0.01 mm and 0.1 mm.

Therefore, it is especially advantageous if the heat-conductive insert is developed as an elastic foil having a thickness of between 0.1 mm and 1.4 mm, preferably of between 0.2 mm and 1.2 mm, and most preferably, of between 0.3 mm and 1.0 mm. This is advantageously in particular if the heat-conductive insert and the heat distribution element are developed as a composite part, and especially as a foil composite part.

In an advantageous manner, the cell holder at least regionally forms an outer side of the first housing component and/or the second housing component of the battery pack housing. In an especially preferred specific embodiment, the cell holder forms the second housing component in its entirety. Here, the battery pack housing preferably has at least two side components, which keep the first housing component and the second housing component together in the assembled state of the battery pack in such a way that a detachment of the first housing component from the second housing component, or vice versa, is prevented.

In this context it is possible that the side components are at least partially made from a metal, preferably an aluminum or a magnesium pressure casting. In this case, a reliable insulation insert has to be used between the battery cells and the side components; it is possible, for example, to use the elastic, heat-conductive insert as insulation inserts.

In another further development of the present invention, the battery pack has two elastic heat-conductive inserts. A heat-conductive insert together with a side component is produced by a 2K injection molding method in each case, preferably in a common working step and in integrated form, in particular. It is advantageous here if the side components are made of the same material as the rest of the battery pack housing, preferably a polyamide.

The cell holder advantageously accommodates two or more battery cells, which are connected by at least one cell connector in a parallel and/or series circuit. The at least one cell connector is situated between an end face of the battery cells and the elastic, heat-conductive insert.

The at least one cell connector advantageously connects at least two or more battery cells, and preferably four battery cells, and most preferably, six battery cells to one another. In a preferred embodiment variant, the cell connector has a large surface such that the cell connector essentially covers the end faces of the battery cells that are connected to each other, and in this way assumes the function of the heat distribution element. It is possible in this context that the heat distribution element and the cell connector are developed as a composite part, and as an integrally developed composite part, in particular. In areas in which no heat transfer is desired and in which a heat transfer is to be prevented as far as possible, the cell connector includes slot-type recesses, so that the heat losses transferred from the battery cells to the cell connectors in a pointwise manner are able to be distributed to the entire surface and are transferred to the elastic element and/or to the side components. In an especially advantageous further development, the elastic, heat-conductive insert is at least regionally in direct thermal contact with the cell connectors.

The battery pack according to the present invention may be connected to a handheld machine tool in a detachable manner. Accordingly, provided it is connected to a battery pack according to the present invention, a handheld machine tool constitutes another subject matter of the present invention. The battery pack used in the handheld machine tool is employed as a drive of the handheld machine tool.

Lithium-ion cells, in particular, may be used as battery cells because in the case of lithium-ion cells, in particular, it is possible to combine a plurality of battery cells into battery cell blocks in which multiple battery cells are connected in a parallel circuit. It is especially advantageous here that the cell holder is able to accommodate battery cells having different diameters and lengths, thereby allowing the cell holder or the cell carrier to be used in a variety of battery packs.

Within the framework of the present application, a handheld machine tool generally denotes all handheld machine tools having a tool carrier that is able to be set into rotation or translation and is able to be driven directly by a drive motor via a transmission or a planetary gear, e.g., straight drills, cordless drills, impact wrenches, multi-function tools, saws, scissors, grinders and/or combination drills, for example. In this context, the transmission of electrical energy is to be understood specifically in such a way that the handheld machine tool is supplied with energy by way of the battery pack.

Additional features, application possibilities and advantages of the present invention result from the description of the exemplary embodiments of the present invention below, which are depicted in the figures. It should be noted that the illustrated features are merely of a descriptive nature and may also be used in combination with features of other further developments described in the previous text. They are also not intended to limit the present invention in any shape or form.

### BRIEF DESCRIPTION OF THE DRAWINGS

The present invention is described in greater detail in the below on the basis of preferred exemplary embodiments, where the same reference numerals have been used for the same features.

FIG. 1 shows, by way of example, a view of a handheld machine tool having a battery pack according to the present invention.

FIG. 2 shows a perspective representation of a battery pack according to the present invention.

FIG. 3 shows a plan view of the battery pack from FIG. 2.

FIG. 4 shows a perspective exploded view of a first variant of a battery pack according to the present invention.

FIG. 5 shows a sectional view of the battery pack from FIG. 4.

FIG. 6 shows a perspective exploded view of a second variant of a battery pack according to the present invention.

FIG. 7 shows sectional view of the battery pack from FIG. 6.

FIG. 8 shows a detail view of region A from FIG. 7 with the second variant of the battery pack according to the present invention.

FIG. 9 shows a detail view of a third variant of the battery pack according to the present invention.

FIG. 10 shows a perspective view of a cell holder having a battery pack electronics system disposed thereon.

FIG. 11 shows a perspective detail view of a cutaway from FIG. 10.

### DETAILED DESCRIPTION OF EXAMPLE EMBODIMENTS

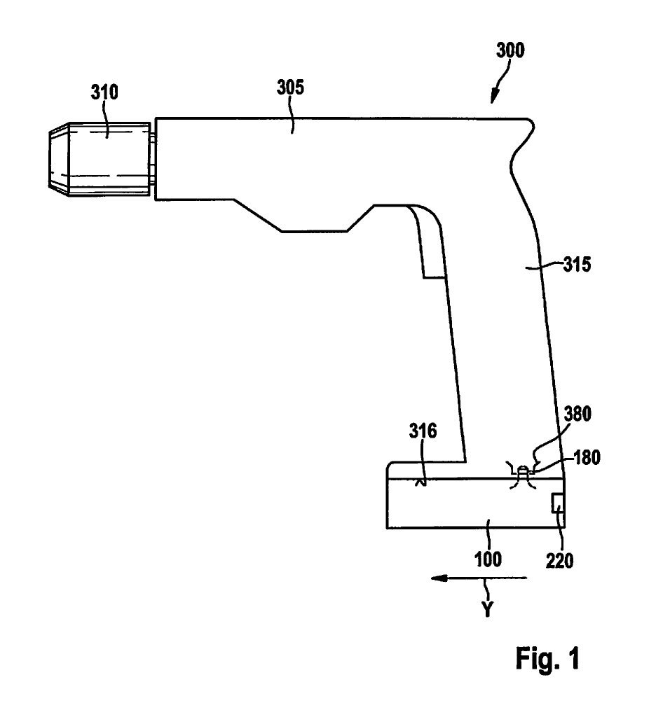

FIG. 1 shows an electric device that is developed as a handheld machine tool 300. According to the specific development illustrated, handheld machine tool 300 is able to be mechanically and electrically connected to battery pack 100 for the mains-independent current supply. In FIG. 1, handheld machine tool 300 is developed as a cordless combination drill by way of example. However, it is pointed out that the present invention is not restricted to cordless combination drills but may instead be used in different handheld machine tools 300 that are operated using a battery pack 100. Handheld machine tool 300 has a base body 305, on which a tool holder 320 is fixed in place; it also has a handle 315 having an interface 380 on which a corresponding interface 180 of a battery pack 100 is situated, in the locked state in this instance. Battery pack 100 is developed as a slide-in battery pack.

When battery pack 100 is mounted on handheld machine tool 300, receiving means provided on handheld machine tool 300, e.g., guide grooves and guide ribs, are brought into engagement with corresponding guide elements 110 of battery pack 100. For this purpose, battery pack 100 is inserted in a sliding direction y along the receiving means of handle 315. Battery pack 100 is slipped into the battery pack receptacle of a handheld machine tool 300 along a lower outer surface 316 of handle 315, said surface being aligned essentially at a right angle to the longitudinal direction of handle 315. In the position shown in FIG. 1, battery pack 100 is fixed in place on handle 315 of handheld machine tool 300 and locked with the aid of locking means. The locking means include a locking element and an operating element 220, among others. By actuating operating means 220, battery pack 100 is able to be detached from handle 315 of handheld machine tool 300.

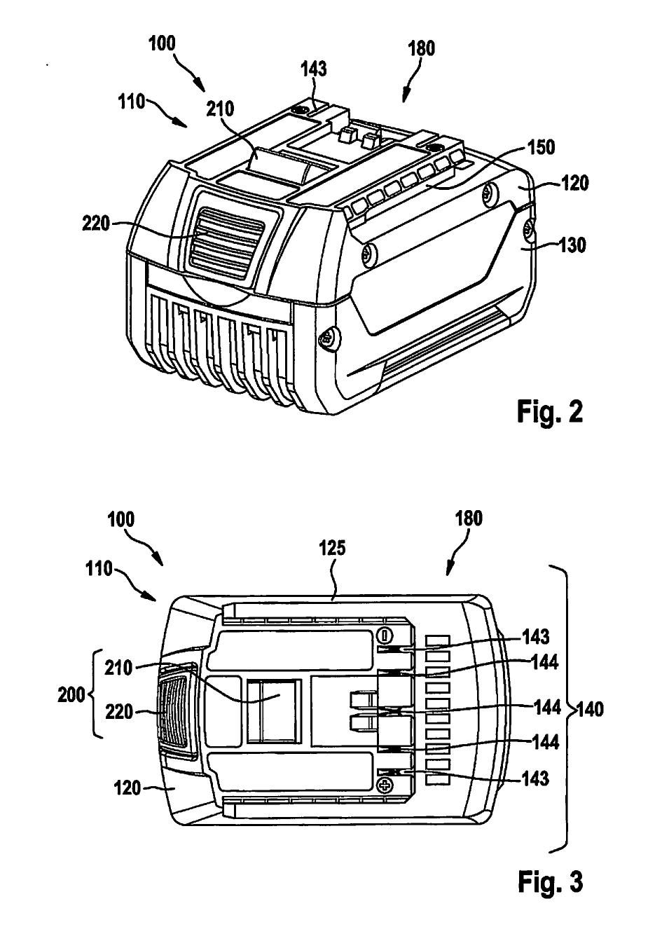

FIGS. 2 through 5 show a battery pack 100 according to the present invention for a handheld machine tool 300. Battery pack 100 has a housing 110 which is made up of a first housing component 120 and a second housing component 130. The housing accommodates at least one, and preferably a plurality (as illustrated here) of battery cells 400 connected in parallel or in series between first housing component 120 and second housing component 130. Battery cells 400 are preferably positioned between the two housing components 120, 130 either with the aid of a cell holder 600 or with the aid of cardboard sleeves in order to insulate battery cells 400 from one another. Battery pack 100 is developed as a slide-in battery pack in the illustrated embodiment variant.

For the detachable mounting of battery pack 100 on a handheld machine tool 300 or on a charge device, battery pack 100 is equipped with an interface 180 for a detachable mechanical and electrical connection to a corresponding interface 380 of handheld machine tool 300 or to a corresponding interface of the charge device. When battery pack 100 is mounted, receiving means, e.g., guide grooves and guide ribs, of handheld machine tool 300 or of the charge device, for the accommodation of the corresponding guide elements of battery pack 100, are brought into an engagement therewith, battery pack 100 being inserted in a contacting direction y along the receiving means, and interface 180 of battery pack 100 being inserted into corresponding interface 380 of handheld machine tool 300 or into the corresponding interface of the charge device. Via interfaces 180, 380, battery pack 100 is able to be allocated to handheld machine tool 300 and/or the charge device.

For the locking of battery pack 100 on handle 315, battery pack 100 is slipped along handle 315 in a sliding direction y, i.e. along a lower outer surface of handle 315 that is aligned essentially at a right angle to the longitudinal direction of handle 315. In the position shown in FIG. 1, battery pack 100 is locked by locking means 200 on handle 315. Among other things, locking means 200 includes a locking element 210, which is illustrated only schematically, as well as an operating element 220. By actuating operating element 220, battery pack 100 is able to be removed from handle 315 of handheld machine tool 300. After battery pack 100 has been unlocked, it is able to be separated from handle 315, i.e., by sliding battery pack 100 counter to sliding direction y along a lower surface of handle 315. When mounting battery pack 100 on a handheld machine tool 300, locking element 210 is brought into engagement with a corresponding receptacle (not shown in greater detail) in handle 315 of handheld machine tool 300.

As is shown in FIG. 3, interface 180 also encompasses contact elements 140 for the electrical contacting of battery pack 100 with handheld machine tool 300 or the charge device. Contact elements 143 are developed as voltage contact elements and are used as charge and/or discharge contact elements. Contact elements 144 are configured as signal contact elements and are used for the transmission of signals from battery pack 100 to handheld machine tool 300 or to the charge device and/or from handheld machine tool 300 or the charge device to battery pack 100.

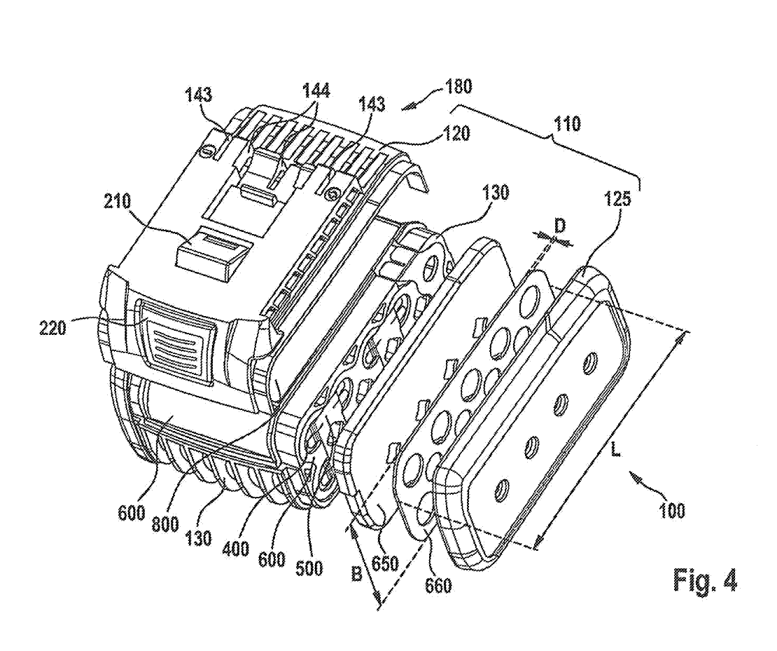

FIG. 4 shows a battery pack 100 in the exploded view. It can be seen clearly that battery pack housing 110 has a cell holder 600 having a plurality of battery cells 400, which are connected in a series circuit. Cell holder 600 is directly formed by second housing component 130. The connection of the battery cells among one another is realized via cell connector 500. In addition, it can be gathered that individual battery cells 400 are accommodated at a distance from one another in cell holder 600 for a mechanical fixation. In addition to fixating battery cells 400 in battery pack housing 120, 130, cell holder 600 is also used for cooling battery cells 400 and made from a heat-conducting material, e.g., aluminum or a plastic material. Furthermore, cell holder 600 has sleeve-type insulation walls, so that individual battery cells 400 are separated and an electrical insulation of the individual battery cells 400 from one another is able to be ensured. The heat-transfer resistance between adjacent battery cells 400 and between battery cells 400 and cell holder 600 is as low as possible, so that the heat losses generated by battery cells 400 are able to be dissipated into the external environment in a satisfactory manner, and overheating of the battery pack on the inside is able to be prevented. Fixed in place on the top surface of cell holder 600 within battery pack housing 120, 130 is a circuit board of a battery pack electronics system 800. In addition, the battery pack electronics system includes contact elements 140 for the establishment of the electrical and mechanical connection between battery pack 100 and handheld machine tool 300 or between battery pack 100 and the charge device. Fastening elements, which are not shown in greater detail, ensure the connection between the battery pack electronics system and cell holder 600.

In the specific embodiment shown in FIG. 4, battery pack housing 110 also has two side components 125, although only one of the two side components 125 is shown in FIG. 4. Side components 125 keep first housing component 120 and second housing component 130 together in the assembled state in such a way that a detachment of first housing component 120 from second housing component 130, or vice versa, is prevented. It is advantageous as a matter of principle if cell holder 600 regionally forms an outer side of second housing component 130 or battery pack 100; however, as an alternative it is also possible for cell holder 600 to regionally form an outer side of first housing component 120. It is advantageous in this context if side components 125 are made of the same material as the rest of battery pack housing 110, preferably of a synthetic, technically usable thermoplastic plastic material such as a polyamide. This makes it possible to reduce costs and to keep the assembly work to a minimum. As an alternative, side components 125 may at least partially be composed of a metal, preferably an aluminum or a magnesium pressure casting. In this case, an adequate or reliable insulation insert, e.g., elastic element 650, must be used between cell connectors 500 and side components 125.

In addition, cell connectors 500, by which an electrical connection of battery cells 400 among one another in a parallel and/or series circuit is able to implemented, are shown in FIG. 4. Each battery cell 400 has a lateral area 405 that runs parallel to a longitudinal axis x. Lateral area 405 is delimited by two end faces 410 that run at a right angle to longitudinal axis x and at which the electrical poles of battery cells 400 are located. An elastic, heat-conductive insert 650 is situated between end faces 410 of battery cells 400 and a wall of battery pack housing 110 that essentially extends parallel to end faces 410 of battery cells 400. Elastic, heat-conductive insert 650 is disposed between battery cells 400 and second housing component 130 of battery pack housing 110 in such a way that a thermal contact is created with end faces 410 of battery cells 400, and heat from battery cells 400 is dissipated in the direction of the wall of battery pack housing 110. Heat-conductive insert 650 is at least partially made of a heat-conducting material that belongs to at least one of the material groups of elastomers, thermoplastic elastomers or carbon fibers. This makes it possible to ensure that heat-conductive insert 650 has a thermal conductivity that is greater than 0.15 W/mK, and preferably greater than 0.20 W/mK, and most preferably, a thermal conductivity that lies between 0.20 W/mK and 0.50 W/mK on the one hand, and a Shore hardness that is less than 50 Shore A, and preferably lies between 20 Shore A and 45 Shore A on the other.

It can furthermore be gathered from FIG. 4 that a heat distribution element 660 is situated in the region of end faces 410 between elastic, heat-conductive insert 650 and the wall of battery pack housing 110. Heat distribution element 660 is in thermal contact both with elastic, heat-conductive insert 650 and the wall of battery pack housing 110, and thus ensures a uniform application of heat to the wall of battery pack housing 110. Heat distribution element 660 is developed in the form of a planar component that has a length L, a width B, and a thickness D, thickness D being low in comparison with length L and width B. Heat distribution element 660 is made of a metal, preferably an aluminum or a magnesium alloy, or of a heat-conducting plastic material. This makes it possible for heat distribution element 660 to aid in a heat transfer in a region where such a heat transfer is desired.

In those regions where the heat transfer is undesired and is to be prevented as much as possible, heat distribution element 660 includes a plurality of recesses 665. These recesses are distributed across the entire surface of heat distribution element 660, one recess 665 being provided for each battery cell 400 in the illustrated specific embodiment. This makes it possible to ensure that the heat losses transferred in a pointwise manner from battery cells 400 to elastic element 650, which is in thermal contact with battery cells 400, are able to be transferred directly to immediately adjoining heat distribution element 660, which is in thermal contact with elastic element 650. Because of recesses 665, heat distribution element 660 distributes the heat losses, which are transferred in a relatively punctual manner, to the entire surface of respective side components 125 of battery pack housing 110, heat distribution element 660 also being in direct thermal conduct with respective side component 125.

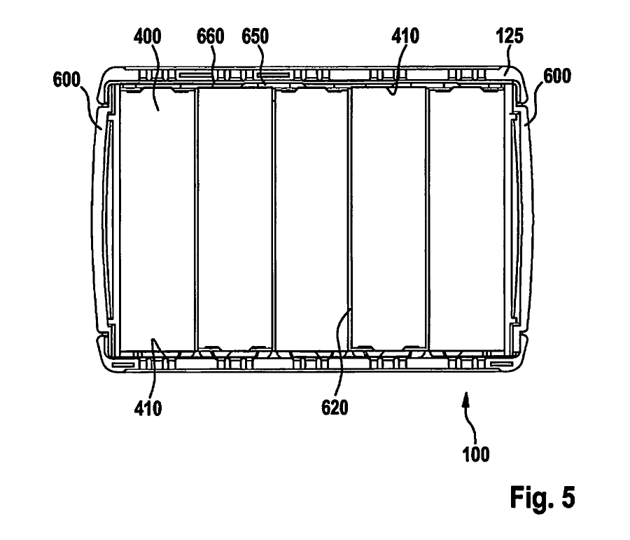

FIG. 5 represents a sectional view of battery pack 100 according to the present invention. Here, too, it can be seen that cell holder 600 forms second housing component 130 and thus also an outer side of battery pack housing 110. In addition, it may be gathered from FIG. 5 that the lateral areas of two battery cells 400 situated next to each other in cell holder 600 do not touch but are mechanically and electrically separated from each other by sleeve-type insulated walls. It can be seen clearly here that elastic, heat-conductive insert 650 is situated between battery cells 400 and a heat distribution element 660. Heat distribution element 660 is disposed between elastic, heat-conductive insert 650 and one of side components 125 of battery pack housing 110. This ensures that end faces 410 of battery cells 400, elastic, heat-conductive insert 650, heat distribution element 660, and side component 125 are in thermal contact, so that the heat from battery cells 400 is able to be dissipated in the direction of the wall of battery pack housing 110.

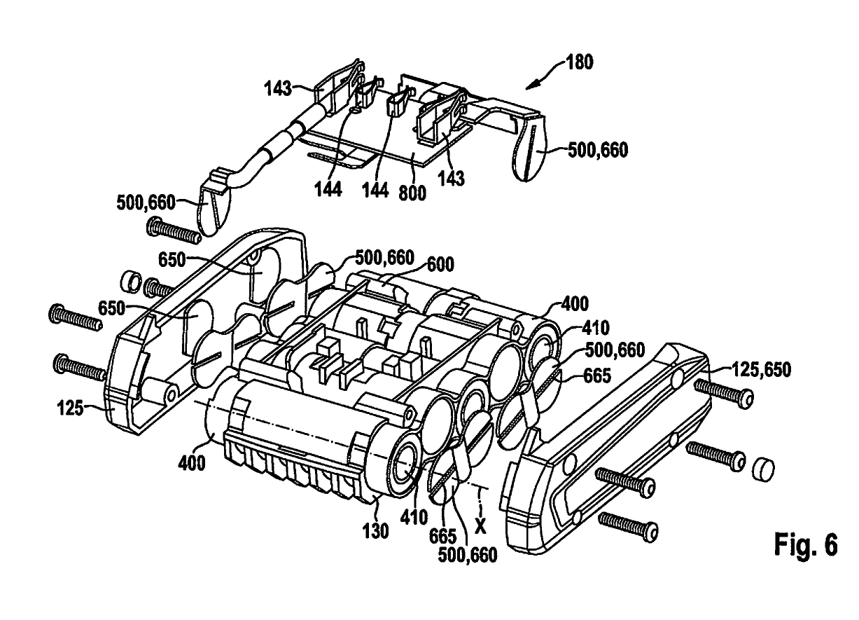

FIG. 6 shows a battery pack 100 in the exploded view. In contrast to battery pack 100 from FIG. 4, cell connectors 500 are developed with such a large surface that in addition to their function of ensuring an electrical connection of battery cells 400 among one another in a parallel and/or series circuit, they are also able to assume the function of heat distribution element 660 and aid in the desired heat transfer. It is advantageous in this context that heat distribution element 660 and cell connector 500 are developed as composite parts, and in particular, as an integrally formed composite part; it also has slot-type recesses 665 in the areas in which the heat transfer is not desired and is to be prevented to the greatest extent possible. A separate recess 665 is provided for each battery cell 400. In this way it can be ensured that the heat losses punctually transferred from battery cells 400 to cell connectors 500 or to heat distribution element 660 are able to be transferred directly to elastic element 650, which is in thermal contact with cell connectors 500. Due to recesses 665, cell connectors 500, which are developed as heat distribution element 660, are able to transmit the heat losses, transferred in a relatively punctual manner, to the entire surface and transfer them to elastic element 650.

Elastic element 650 may be in direct thermal contact with respective side component 125. As can be gathered from FIG. 6, elastic, heat-conductive insert 650 is situated directly in side component 125 of battery pack housing 110 or is even produced in one piece with side component 125. If side components 125 are made from the same material as the rest of battery pack housing 110, preferably a synthetic, technically usable thermoplastic plastic material such as a polyamide, then this makes it possible to produce heat-conductive insert 650 together with a side component 125 in an injection-molding process, such as a 2K injection molding process, and preferably in a common working step and in one piece, in particular. Costs are able to be reduced in this way, and the assembly work is kept to a minimum. It is advantageous that heat-conductive insert 650 is at least partially made of a heat-conducting material such as an elastomer or a thermoplastic elastomer. Heat distribution element 660 or cell connectors 500 are therefore in thermal contact both with elastic, heat-conductive insert 650 and with the wall of battery pack housing 110, thereby ensuring a uniform application of heat to the wall of battery pack housing 110.

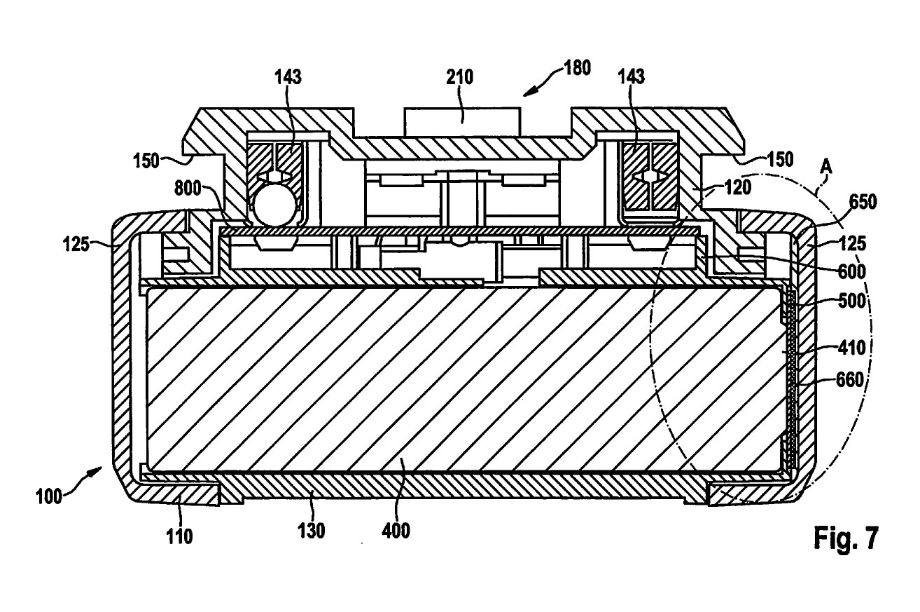

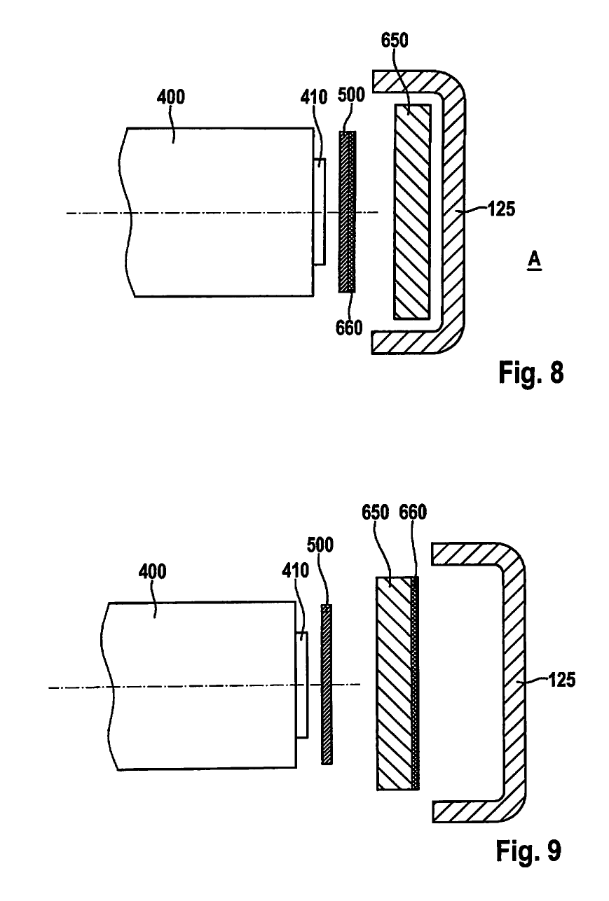

FIG. 7 represents a sectional view of battery pack 100 from FIG. 6 according to the present invention. Here, too, it can be gathered that battery pack housing 110 has two side components 125. In addition, it can be seen there, but especially clearly and in detail in FIG. 8, that cell connectors 500 are developed in such a way that they are able to assume the function of heat distribution element 660 and aid in the desired heat transfer to elastic, heat-conductive insert 650. Elastic, heat-conductive insert 650 is disposed in side components 125 of battery pack housing 110 or, as described in the preceding text, is integrally formed with said side components. This ensures that end faces 410 of battery cells 400, heat distribution element 660, elastic, heat-conductive insert 650, and side component 125 are in thermal contact, so that the heat from battery cells 400 is able to be dissipated in the direction of the wall of battery pack housing 110.

FIG. 9 shows an alternative, third embodiment variant of battery pack 100 according to the present invention. In this specific embodiment, heat-conductive insert 650 and heat distribution element 660 are developed as a composite material, and as a foil composite material, in particular. It is especially advantageous here if heat distribution element 660 is developed as a metal foil having a thickness of between 0.1 mm and 0.5 mm, and preferably of between 0.01 mm and 0.3 mm, or as a graphite layer having a thickness of between 0.1 mm and 0.5 mm, and preferably of between 0.01 mm and 0.1 mm, and if heat-conductive insert 650 is developed as an elastic foil having a thickness of between 0.1 mm and 1.4 mm, and preferably of between 0.2 mm and 1.2 mm, and most preferably, of between 0.3 mm and 1.0 mm.

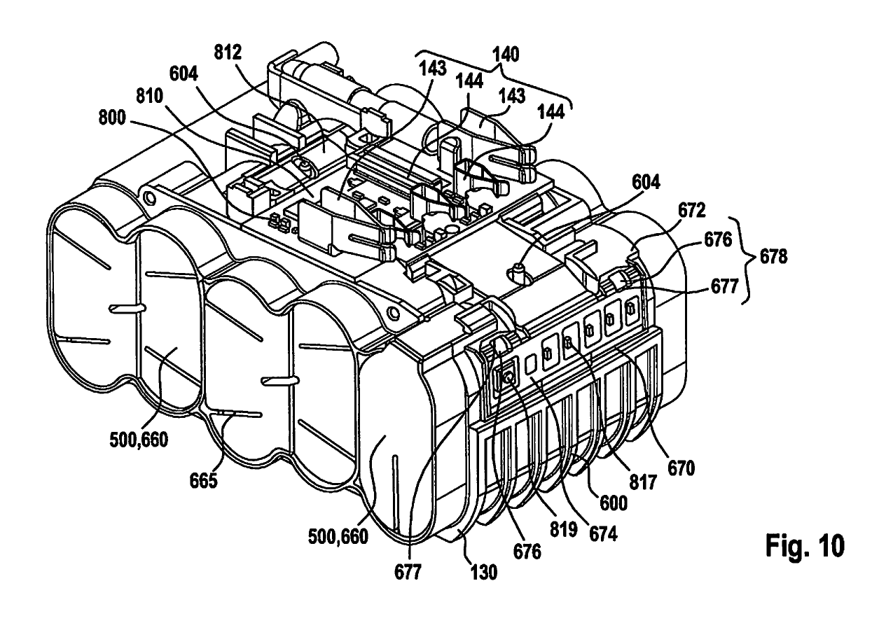

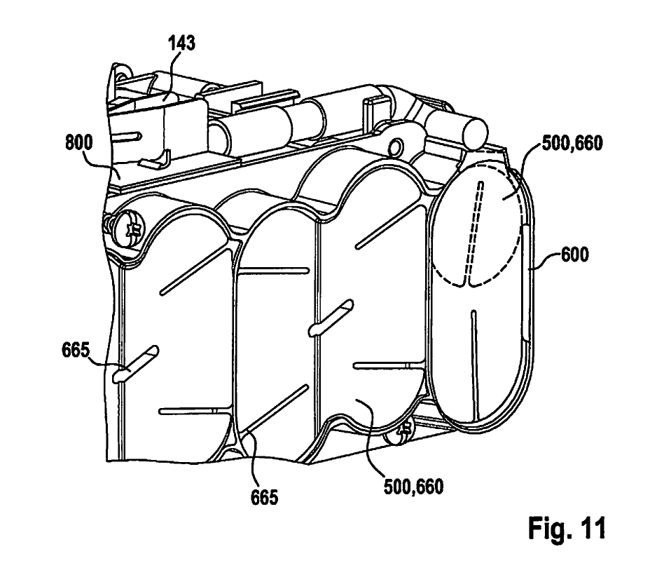

As is clear from FIG. 6 and especially also from FIGS. 10 and 11, in one preferred specific embodiment cell connectors 500 have such a large surface that in addition to their function of ensuring an electrical connection of battery cells 400 among one another in a parallel and/or series circuit, they are also able to assume the function of heat distribution element 660 and aid in the desired heat transfer. It is advantageous here that a cell connector 500 connects at least two battery cells 400, and preferably four battery cells 400, or any random number of battery cells to one another in a parallel and/or series circuit. It is clear from FIGS. 6, 10 and 11 that cell connector 500 is designed to be variable in its specific embodiment and is basically able to be adapted to the specific embodiment of cell holder 600 or to the respective number of battery cells 400. In the embodiment variant illustrated, cell connectors 500 are developed with a large surface such that end faces 410, which are connected to one another via a cell connector 500, are completely covered for the most part. A large-surface specific embodiment of cell connector 500 means that, if it connects two battery cells or four battery cells 400 to one another as shown in FIGS. 6, 10, and 11, it largely covers respective end faces 410 of these two battery cells 400 or four battery cells 400. This makes it possible to ensure that installed cell connectors 500 are able to assume the function of heat distribution element 660. As an alternative, heat distribution element 660 and cell connector 500 may be developed as a composite part, and as an integrally formed composite part, in particular.

In the large-surface cell connectors shown in FIGS. 6, 10, and 11, slot-type recesses 665 are likewise situated in regions in which no heat transfer is desired and is to be prevented as far as possible, so that the heat losses punctually transferred from battery cells 400 to cell connectors 500 are able to be transferred directly to elastic element 650, which is in thermal contact with cell connectors 500.

In addition to the described and illustrated specific embodiments, additional specific embodiments that may encompass additional modifications as well as combinations of features are possible.

1-20. (canceled)

21. A battery pack for a handheld machine tool, comprising:
a battery pack housing;
a cell holder accommodated in the battery pack housing;
at least one battery cell, the cell holder accommodating the at least one battery cell, and the at least one battery cell having a lateral area that extends parallel to a longitudinal axis, the lateral area being delimited by two end faces extending at a right angle to the longitudinal axis, on which electrical poles of the at least one battery cell are situated; and
at least one elastic, heat-conductive insert situated between at least one end face of the at least one battery cell and a wall of the battery pack housing extending parallel to the end face of the at least one battery cell, the elastic, heat-conductive insert being in thermal contact with the end face of the at least one battery cell and dissipating heat from the at least one battery cell in a direction of the wall of the battery pack housing.

22. The battery pack as recited in claim 21, wherein at least one heat distribution element is situated in the region of the at least one end face of the at least one battery cell, between the at least one elastic, heat-conductive insert and the wall of the battery pack housing, the heat distribution element being in thermal contact with the elastic, heat-conductive insert and the wall of the battery pack housing and ensuring a uniform application of heat to the wall of the battery pack housing.

23. The battery pack as recited in claim 21, wherein the at least one heat-conductive insert is at least partially made of a heat-conducting material that belongs to at least one of the material groups of elastomers, thermoplastic elastomers or carbon fibers.

24. The battery pack as recited in claim 21, wherein the heat-conductive insert has a thermal conductivity that is greater than 0.15 W/mK.

25. The battery pack as recited in claim 21, wherein the heat-conductive insert has a Shore hardness of less than 50 Shore A.

26. The battery pack as recited in claim 21, wherein the heat-conductive insert is an elastic foil having a thickness of between 0.1 mm and 1.4 mm.

27. The battery pack as recited in claim 22, wherein the heat distribution element is at least partially made from a metal.

28. The battery pack as recited in claim 22, wherein the heat distribution element is a planar component having a length L, a width B, and a thickness D, thickness D being small in comparison with length L and width B, and the heat distribution element has a plurality of recesses distributed across its surface.

29. The battery pack as recited in claim 22, wherein the heat distribution element is a metal foil having a thickness of between 0.1 mm and 0.5 mm.

30. The battery pack as recited in claim 22, wherein the heat-conductive insert and the heat distribution element are developed as a foil composite part.

31. The battery pack as recited in claim 22, wherein the cell holder accommodates two or more battery cells, which are connected by at least one cell connector in a parallel and/or series circuit, the at least one cell connector being situated between an end face of the battery cells and the elastic, heat-conductive insert.

32. The battery pack as recited in claim 31, wherein the at least one cell connector connects at least two or more battery cells to one another.

33. The battery pack as recited in claim 32, wherein the at least one cell connector is developed in such a way that the cell connector covers the end faces of the battery cells are connected to one another.

34. The battery pack as recited in claim 31, wherein the elastic, heat-conductive insert is at least regionally in direct thermal contact with the at least one cell connector.

35. The battery pack as recited in claim 31, wherein the heat distribution element and the at least one cell connector are developed as an integrally formed composite part.

36. The battery pack as recited in claim 21, wherein the cell holder at least regionally forms an outer side of a first housing component and/or a second housing component of the battery pack housing.

37. The battery pack as recited in claim 36, wherein the battery pack housing has at least two side components, the side components holding the first housing component and the second housing component together in the assembled state of the battery pack in such a way that a detachment of the first housing component from the second housing component, or vice versa, is prevented.

38. The battery pack as recited in claim 37, wherein the side components are at least partially made from a metal.

39. The battery pack as recited in claim 37, wherein the battery pack has two elastic, heat-conductive inserts, and a heat-conductive insert together with a side component are produced in a 2K injection-molding process in each case, in a common working step and in one piece.

40. A handheld machine tool, comprising:
an electric motor; and
a battery pack including a battery pack housing, a cell holder accommodated in the battery pack housing, at least one battery cell, the cell holder accommodating the at least one battery cell, and the at least one battery cell having a lateral area that extends parallel to a longitudinal axis, the lateral area being delimited by two end faces extending at a right angle to the longitudinal axis, on which electrical poles of the at least one battery cell are situated, and at least one elastic, heat-conductive insert situated between at least one end face of the at least one battery cell and a wall of the battery pack housing extending parallel to the end face of the at least one battery cell, the elastic, heat-conductive insert being in thermal contact with the end face of the at least one battery cell and dissipating heat from the at least one battery cell in a direction of the wall of the battery pack housing;
wherein the battery pack is detachably connected to the handheld machine tool.
